(19) United States
(12) Patent Application Publication
(10) Pub. No.: US 2023/0054049 A1
(43) Pub. Date: Feb. 23, 2023

(54) DELIVERY SYSTEM

(71) Applicant: TOYOTA JIDOSHA KABUSHIKI KAISHA, Aichi-ken (JP)

(72) Inventors: Tetsuya KANATA, Toyota-shi (JP); Tomoko ASAI, Nagoya-shi (JP); Kohki BABA, Susono-shi (JP); Kei SATO, Toyota-shi (JP); Takashi HAYASHI, Nagoya-shi (JP); Manabu NAGAI, Nagoya-shi (JP)

(21) Appl. No.: 17/858,071

(22) Filed: Jul. 6, 2022

(30) Foreign Application Priority Data
Aug. 17, 2021 (JP) 2021-132924

(51) Int. Cl. G06Q 10/08; A47G 29/30; B60P 3/00; G07C 9/00; G06V 20/58

(52) U.S. Cl. CPC G06Q 10/0833; A47G 29/30; B60P 3/00; G06V 20/58; G07C 9/00174; A47G 2029/145

(57) ABSTRACT

A delivery vehicle is configured to be able to deliver a package in front of a front door of a dwelling unit in a complex housing including a shared door with automatic lock function that is able to be opened as unlock information is input to an unlock input unit of an entrance via wireless communication. When the delivery vehicle arrives at the complex housing including the shared door with automatic lock function, and a delivery instruction for leaving the package in front of the front door is made, an on-board unit of the delivery vehicle inputs the unlock information to the unlock input unit via the wireless communication, and notifies a terminal device of a user of input date and time.

### CROSS-REFERENCE TO RELATED APPLICATION

This application claims priority to Japanese Pat. Application No. 2021-132924 filed on Aug. 17, 2021, incorporated herein by reference in its entirety.

### BACKGROUND

### 1. Technical Field

The present disclosure relates to a delivery system.

### 2. Description of Related Art

A system for managing entry and leaving of a person in a managed area (see Japanese Unexamined Patent Application Publication No. 2007-247141 (JP 2007-247141 A) below) and a method for improving security of a storage box (see Japanese Unexamined Pat. Application Publication No. 2002-304373 (JP 2002-304373 A) below) are known. These techniques can be applied to ensure security in a location where an item is delivered.

### SUMMARY

There is a need for delivering a package in front of a front door of a dwelling unit of a user in a complex housing in which a shared door with automatic lock function at an entrance can be opened as unlock information is input via wireless communication.

However, the user cannot entrust a delivery service to which only the above-mentioned related art is applied to delivery of the package in front of the front door of the dwelling unit in the complex housing.

In view of the above fact, an object of the present disclosure is to provide a delivery system that the user can entrust to delivery of a package in front of a front door of the dwelling unit in the complex housing in which the shared door with automatic lock function at the entrance can be opened as the unlock information is input via wireless communication.

A delivery system of the present disclosure according to claim 1 includes: a delivery vehicle configured to be able to deliver a package in front of a front door of a dwelling unit in a complex housing including a shared door with automatic lock function that is installed at an entrance such that the shared door is able to be opened and closed, and that is able to be opened as unlock information managed by a key management system is input to an unlock input unit of the entrance via wireless communication; a delivery information acquisition unit that acquires information on delivery including delivery destination information on the package and information indicating presence or absence of a delivery instruction for leaving the package in front of the front door; a contact information acquisition unit that acquires contact information on a user of delivery destination; an unlock information acquisition unit that acquires the unlock information in the complex housing based on information from the key management system when determination is made that the delivery instruction for leaving the package in front of the front door is made and the delivery destination indicated by the delivery destination information is the dwelling unit in the complex housing based on information acquired by the delivery information acquisition unit; an unlock request unit that inputs the unlock information corresponding to the complex housing to the unlock input unit of the complex housing via the wireless communication based on information acquired by the unlock information acquisition unit when the delivery vehicle for delivering the package arrives at the complex housing and when determination is made that the delivery instruction for leaving the package in front of the front door is made based on information acquired by the delivery information acquisition unit; a record unit that records information on a date and time, and a location at which the unlock request unit inputs the unlock information to the unlock input unit; and a notification unit that notifies the user of the date and time at which the unlock information is input to the unlock input unit so as to deliver the package in front of the front door of the dwelling unit of the user based on information acquired by each of the delivery information acquisition unit and the contact information acquisition unit and information recorded in the record unit.

With the above configuration, the delivery system includes the delivery vehicle configured to be able to deliver the package in front of the front door of the dwelling unit in the complex housing including the shared door with automatic lock function that is installed at the entrance such that the shared door is able to be opened and closed, and that is able to be opened as the unlock information managed by the key management system is input to the unlock input unit of the entrance via wireless communication. The delivery information acquisition unit acquires the information on the delivery including the delivery destination information on the package and the information indicating the presence or absence of the delivery instruction for leaving the package in front of the front door. The contact information acquisition unit acquires the contact information on the user of the delivery destination. When determination is made that the delivery instruction for leaving the package in front of the front door is made and the delivery destination indicated by the delivery destination information is the dwelling unit in the complex housing based on the information acquired by the delivery information acquisition unit, the unlock information acquisition unit acquires the unlock information in the complex housing based on the information from the key management system. When the delivery vehicle for delivering the package arrives at the complex housing, and when determination is made that the delivery instruction for leaving the package in front of the front door is made based on the information acquired by the delivery information acquisition unit, the unlock request unit inputs the unlock information corresponding to the complex housing to the unlock input unit of the complex housing via the wireless communication based on the information acquired by the unlock information acquisition unit. Further, the record unit records the information on the date and time, and the location at which the unlock request unit inputs the unlock information to the unlock input unit. Further, the notification unit notifies the user of the date and time at which the unlock information is input to the unlock input unit so as to deliver the package in front of the front door of the dwelling unit of the user based on the information acquired by each of the delivery information acquisition unit and the contact information acquisition unit and the information recorded in the record unit. As a result, the user can confirm the date and time at which the unlock information is input to the unlock input unit so as to deliver the package in front of the front door of the own dwelling unit, so the user can entrust the delivery system to delivery of the package in front of the front door of the own dwelling unit.

The delivery system of the present disclosure according to claim 2 includes, in the configuration according to claim 1, a peripheral information detection sensor that detects peripheral information of the delivery vehicle; and a determination unit that determines whether a person is present in a peripheral area within a predetermined range from the delivery vehicle at the entrance based on the peripheral information detected by the peripheral information detection sensor when the delivery vehicle arrives at the entrance of the complex housing. The unlock request unit inputs the unlock information to the unlock input unit after the determination unit determines that a person is not present in the peripheral area.

According to the above configuration, the peripheral information detection sensor detects the peripheral information of the delivery vehicle. Further, when the delivery vehicle arrives at the entrance of the complex housing, the determination unit determines whether the person is present in the peripheral area within the predetermined range from the delivery vehicle at the entrance based on the peripheral information detected by the peripheral information detection sensor. The unlock request unit inputs the unlock information to the unlock input unit after the determination unit determines that the person is not present in the peripheral area. As a result, when the unlock request unit inputs the unlock information to the unlock input unit of the complex housing and the shared door is opened, it is possible to effectively prevent or suppress a person for which the unlock information is not input to the unlock input unit from entering a building (so-called tailgating).

As described above, the delivery system of the present disclosure has an advantageous effect that enables the user to entrust the delivery system to delivery of the package in front of the front door of the dwelling unit in the complex housing in which the shared door with automatic lock function at the entrance can be opened as the unlock information is input via the wireless communication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a schematic configuration of a delivery system according to an embodiment of the present disclosure;

FIG. 2 is a schematic plan view showing an example of a state in which a delivery vehicle delivers a package in complex housing;

FIG. 3 is a block diagram showing part of a hardware configuration of the delivery vehicle;

FIG. 4 is a block diagram showing an example of a functional configuration of an on-board unit of the delivery vehicle;

FIG. 5 is a flowchart showing an example of a flow of a delivery control process by the on-board unit; and

FIG. 6 is a flowchart showing an example of a delivery process routine that uses unlock information.

### DETAILED DESCRIPTION OF EMBODIMENTS

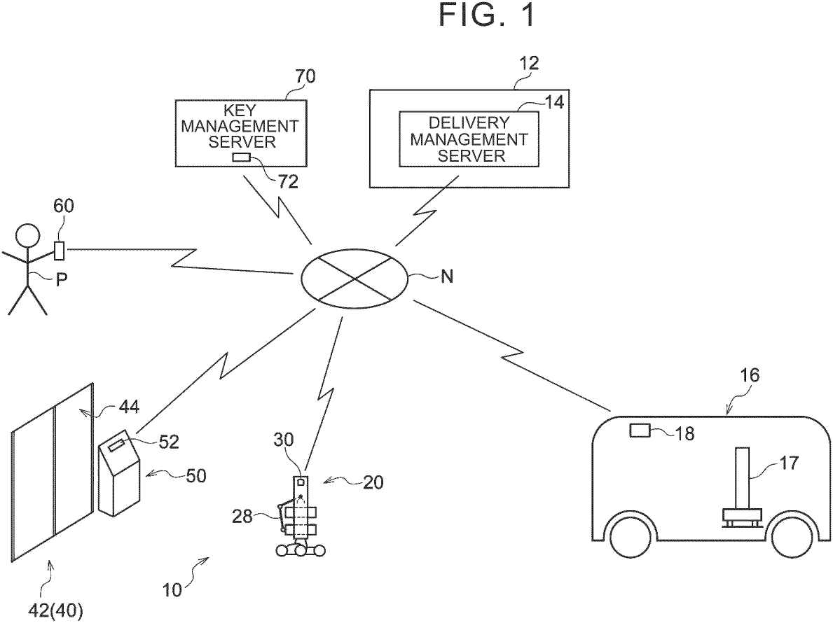

A delivery system according to an embodiment of the present disclosure will be described with reference to FIGS. 1 to 6.

FIG. 1 is a diagram showing an example of a schematic configuration of a delivery system 10 according to the embodiment. As shown in FIG. 1, the delivery system 10 is configured to include a delivery management server 14, a delivery base vehicle 16, and a delivery vehicle 20. The delivery management server 14 is provided in a distribution center 12 as an example. Luggage to be delivered (package) is accumulated in the distribution center 12. Further, the delivery management server 14 stores information on delivery including delivery destination information on the package (including information on the address (that is, position) and the name of a delivery source) and information indicating presence or absence of a delivery instruction for leaving the package in front of a front door, contact information of a user of the delivery destination (including information on an e-mail address of the user), and unlock information in complex housing 40 described below as for a predetermined delivery request item.

The delivery base vehicle 16 can load the package, and is a large vehicle constituting a delivery base for passing the package to one or more delivery vehicles 20 (showing only one delivery vehicle 20 in FIG. 1) and configured to move in the delivery base. The packages to be delivered in a predetermined region are loaded to the delivery base vehicle 16 in the distribution center 12. Further, a plurality of the delivery vehicles 20 can also be loaded to the delivery base vehicle 16 such that the delivery vehicles 20 can be taken in and out.

The delivery base vehicle 16 is an electrified vehicle and an autonomous vehicle capable of autonomous traveling on a road as an example, and includes a control function for autonomous traveling based on notification from the delivery management server 14. The delivery base vehicle 16 may travel without an occupant or travel with an occupant. Further, the delivery base vehicle 16 may be a vehicle that is driven by an occupant or that assists driving of the occupant according to a situation. As an example, the delivery base vehicle 16 is provided with an automatic loading and unloading device 17 (simplified in FIG. 1) for automatically executing loading and unloading the packages at a point where the packages are unloaded.

The delivery vehicle 20 moves so as to deliver the package to a predetermined delivery destination in an area in charge, and when the loaded packages have been delivered, the delivery vehicle 20 moves to a location where packages are passed from the delivery base vehicle 16 to the delivery vehicle 20 so as to load the packages. The delivery vehicle 20 is an electrified vehicle and an autonomous vehicle capable of autonomous traveling on a road, and includes a control function for autonomous traveling based on notification from the delivery management server 14. The delivery vehicle 20 can be also referred to as an autonomous traveling pallet.

The delivery base vehicle 16 includes an on-board unit 18, and the delivery vehicle 20 includes an on-board unit 30. The delivery management server 14, the on-board unit 18 of the delivery base vehicle 16, and the on-board unit 30 of the delivery vehicle 20 are connected with each other via a network N.

Further, a complex entrance device 50, a personal (user P) terminal device 60, and a key management server 70 are connected to the network N. The terminal device 60 includes a portable computer device such as a smartphone and a tablet terminal, and also includes an unportable computer device. The information on delivery including delivery destination information on the package and information indicating presence or absence of a delivery instruction for leaving the package in front of the front door, and the contact information of a user of the delivery destination described above can be input from the terminal device 60 to the delivery management server 14. The key management server 70 is a cloud server as an example, and is provided with a key management system 72 for managing the unlock information (also referred to as unlock password or authentication key).

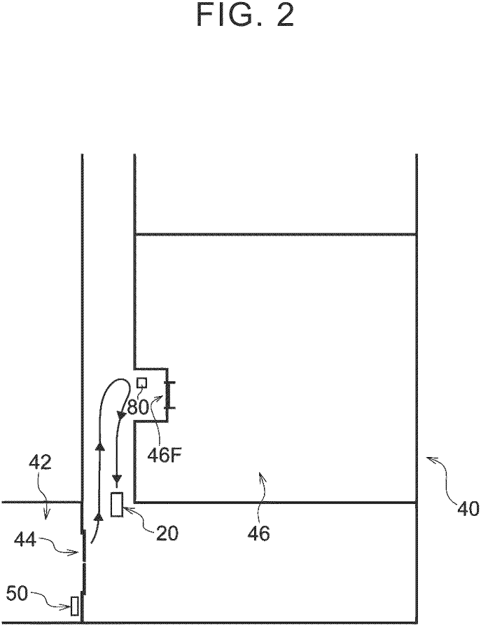

The complex entrance device 50 is installed in an entrance 42 of the complex housing 40 (see FIG. 2), and is provided with an unlock input unit 52. A shared door 44 with automatic lock function is provided at the entrance 42 of the complex housing 40 so as to be opened and closed. Opening and closing of the shared door 44 is controlled by the complex entrance device 50, and the shared door 44 can be unlocked as the unlock information managed by the key management system 72 is input to the unlock input unit 52 of the entrance 42 via wireless communication.

The key management system 72 provided in the key management server 70 can accept registration of unlock information corresponding to the shared door 44. That is, for example, a person (user P) who has the predetermined authorization in the complex housing 40 can register the unlock information corresponding to the shared door 44 using the key management system 72. Further, the key management system 72 is a system in which the unlock information is assumed to be given to other persons than residents in the complex housing 40, and as an example, the name, the e-mail address, and the like of the person to which the unlock information is given can also be input to the key management system 72. In this key management system 72, when the e-mail address of the person to which the unlock information is given (for example, a delivery operator who has the delivery management server 14, the delivery base vehicle 16, and the delivery vehicle 20) is input in a screen in which the unlock information is given to the other persons than the residents, the unlock information given to the person is transmitted to the e-mail address of the person.

In the key management system 72, it is possible to issue unlock information (password) to other persons than the residents of the complex housing 40, which is different from the unlock information possessed by the residents of the complex housing 40. Further, in the key management system 72, it is also possible to set the date, the time zone, the day, and the like at which newly issued unlock information is effective.

Next, the delivery vehicle 20 will be described in detail. As shown in the schematic plan view of part of the complex housing 40 in FIG. 2, the delivery vehicle 20 is configured to be able to deliver a package 80 in front of a front door 46F of a dwelling unit 46 of the complex housing 40 in which the shared door 44 with automatic lock function is installed at the entrance 42. Detailed description of a technique for autonomous traveling to a destination will be omitted since the known technique can be applied.

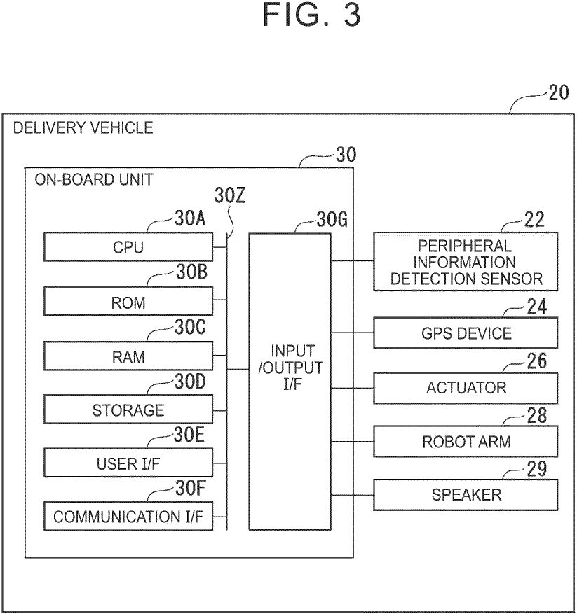

FIG. 3 is a block diagram showing part of a hardware configuration of the delivery vehicle 20. As shown in FIG. 3, the delivery vehicle 20 is configured to include the on-board unit 30, a peripheral information detection sensor 22, a global positioning system (GPS) device 24, an actuator 26, a robot arm 28, and a speaker 29. The on-board unit 18 of the delivery base vehicle 16 described above (see FIG. 1 for both) has substantially the same hardware configuration as the on-board unit 30 of the delivery vehicle 20. Further, the delivery base vehicle 16 (see FIG. 1) has hardware corresponding to each of the peripheral information detection sensor 22, the GPS device 24, and the actuator 26 shown in FIG. 3.

The peripheral information detection sensor 22 detects peripheral information of the delivery vehicle 20, and is configured to include a camera and the like for capturing an image of the peripheral area of the delivery vehicle 20. The GPS device 24 acquires the current position of the delivery vehicle 20. The actuator 26 performs acceleration and deceleration, and steering operations of the delivery vehicle 20. The robot arm 28 operates so as to take out the package from the delivery vehicle 20 and place the package when the package is placed in the delivery destination, for example. The speaker 29 is a device for outputting sound.

The on-board unit 30 is configured to include a central processing unit (CPU: processor) 30A, a read-only memory (ROM) 30B, a random access memory (RAM) 30C, a storage 30D, a user interface 30E (in FIG. 3 and hereinafter abbreviated as “user I/F 30E”), a communication interface 30F (in FIG. 3 and hereinafter abbreviated as “communication I/F 30F”), and an input/output interface 30G (in FIG. 3 and hereinafter abbreviated as “input/output I/F 30G”). The CPU 30A, the ROM 30B, the RAM 30C, the storage 30D, the user I/F 30E, the communication I/F 30F, and the input/output I/F 30G are connected so as to be able to communicate with each other via a bus 30Z.

The CPU 30A is a central processing unit that executes various programs and that controls various units. That is, the CPU 30A reads the program from the ROM 30B or the storage 30D and executes the program using the RAM 30C as a work area. The CPU 30A controls each configuration and performs various arithmetic processes in accordance with the program recorded in the ROM 30B or the storage 30D.

The ROM 30B stores various programs and various data. The RAM 30C temporarily stores a program or data as a work area. The storage 30D is composed of a hard disk drive (HDD) or a solid state drive (SSD), and stores various programs and various data. In the present embodiment, the ROM 30B and the storage 30D store a delivery program for delivering luggage to the delivery destination.

The user I/F 30E is an interface for when the user uses the on-board unit 30. The user I/F 30E includes, for example, at least one of a liquid crystal display including a touch panel that allows a touch operation by the user, a sound input receiving unit for receiving sound input from the user, a button that can be pressed by the user, and the like.

The communication I/F 30F is an interface for the on-board unit 30 to communicate with the complex entrance device 50 and other devices. For the communication, for example, wireless communication standards such as fourth generation (4G), fifth generation (5G), and Wi-Fi (registered trademark) are used. The communication I/F 30F is connected to the network N (see FIG. 1).

The input/output I/F 30G is an interface for communicating with various devices mounted on the delivery vehicle 20. Each of the peripheral information detection sensor 22, the GPS device 24, the actuator 26, the robot arm 28, and the speaker 29 is connected to the input/output I/F 30G as an example. The peripheral information detection sensor 22, the GPS device 24, the actuator 26, the robot arm 28, and the speaker 29 may be connected to the bus 30Z directly.

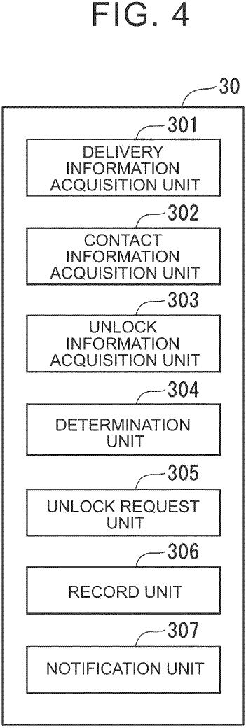

FIG. 4 shows an example of a functional configuration of the on-board unit 30 by a block diagram. As shown in FIG. 4, the on-board unit 30 includes, as the functional configuration, a delivery information acquisition unit 301, a contact information acquisition unit 302, an unlock information acquisition unit 303, a determination unit 304, an unlock request unit 305, a record unit 306, and a notification unit 307. Each functional configuration is realized by the CPU 30A reading and executing the program (delivery program described above) stored in the ROM 30B or the storage 30D.

The delivery information acquisition unit 301 acquires information on delivery including delivery destination information on the package and information indicating presence or absence of a delivery instruction for leaving the package in front of the front door. The delivery destination information on the package includes information on the address (that is, position) and the name of the delivery destination. The contact information acquisition unit 302 acquires the contact information on the user P of the delivery destination. The contact information includes information on the e-mail address of the user P. When the unlock information acquisition unit 303 determines that the delivery instruction for leaving the package in front of the front door is made and the delivery destination indicated by the delivery destination information is the dwelling unit in the complex housing 40 based on the information acquired by the delivery information acquisition unit 301, the unlock information acquisition unit 303 acquires unlock information in the complex housing 40 based on the information from the key management system 72.

When the delivery vehicle 20 arrives at the entrance 42 of the complex housing 40, the determination unit 304 determines whether a person is present in the peripheral area within a predetermined range from the delivery vehicle 20 at the entrance 42 based on the peripheral information detected by the peripheral information detection sensor 22.

When the delivery vehicle 20 for delivering the package arrives at the complex housing 40, and it is determined that the delivery instruction for leaving the package in front of the front door is made based on the information acquired by the delivery information acquisition unit 301, the unlock request unit 305 inputs the unlock information corresponding to the complex housing 40 to the unlock input unit 52 of the complex housing 40 based on the information acquired by the unlock information acquisition unit 303. In the present embodiment, after the determination unit 304 determines that a person is not present in the peripheral area within the predetermined range from the delivery vehicle 20 at the entrance 42, the unlock request unit 305 inputs the unlock information to the unlock input unit 52.

The record unit 306 records information on the date and time, and the location at which the unlock request unit 305 inputs the unlock information to the unlock input unit 52. The notification unit 307 notifies the user P of the date and time at which the unlock information is input to the unlock input unit 52 so as to deliver the package 80 in front of the front door 46F of the dwelling unit 46 of the user P based on the information acquired by each of the delivery information acquisition unit 301 and the contact information acquisition unit 302 and the information recorded in the record unit 306.

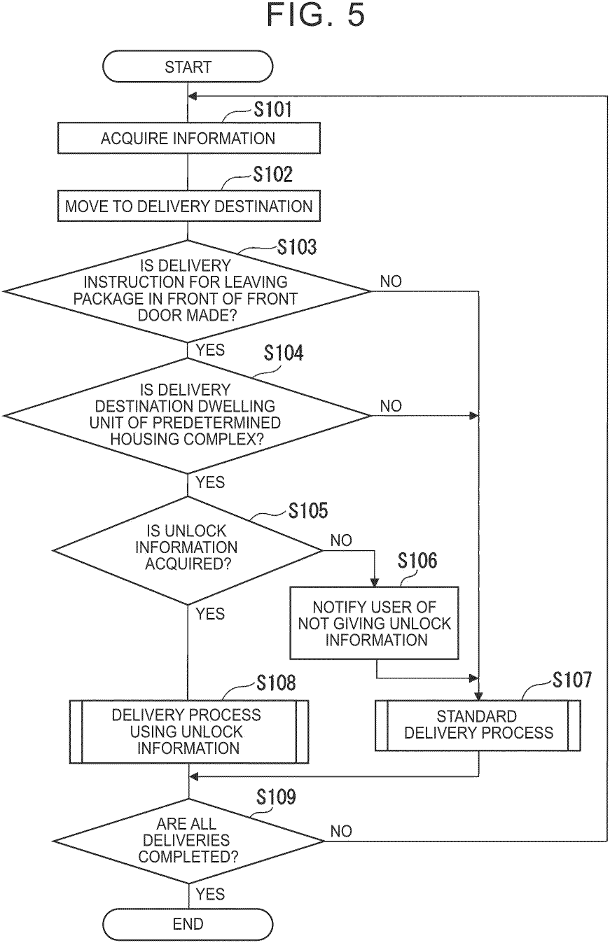

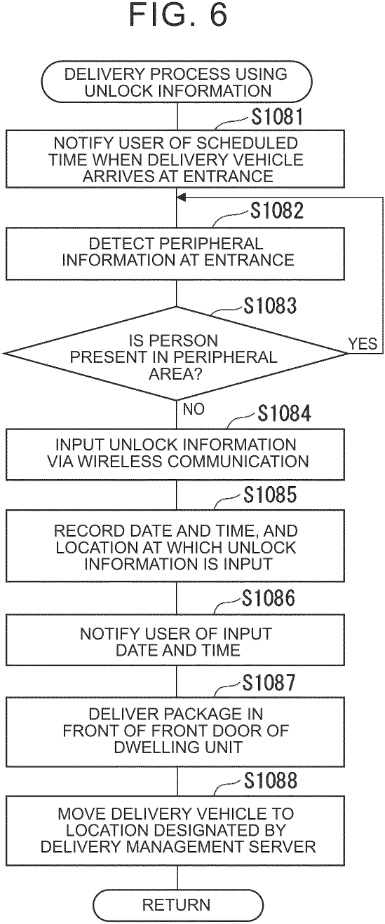

Next, as an effect of the present embodiment, a flow of the process executed by the on-board unit 30 of the delivery vehicle 20 will be described with reference to the flowchart shown in FIG. 5. As an example, the processes shown in FIGS. 5 and 6 are performed by the CPU 30A reading the delivery program from the ROM 30B or the storage 30D and loading the delivery program to the RAM 30C when a predetermined operation (delivery start operation) is performed via the user I/F 30E of the on-board unit 30.

First, the CPU 30A acquires information on delivery including delivery destination information on the package and information indicating presence or absence of a delivery instruction for leaving the package in front of a front door, and contact information on the user of the delivery destination from the delivery management server 14, and when the delivery destination is the dwelling unit 46 of the complex housing 40 and the delivery instruction for leaving the package in front of the front door 46F is made, the CPU 30A further acquires unlock information in the complex housing 40 based on the information from the key management system 72 (step S101). As additional information on acquisition of the unlock information, the unlock information and the like transmitted by e-mail by the key management system 72 when the unlock information is given to the delivery operator who possesses the delivery management server 14, the delivery base vehicle 16, and the delivery vehicle 20 is stored in a database of the delivery management server 14 as an example, and in step S101, the CPU 30A acquires the applicable unlock information from the database of the delivery management server 14.

Next, the CPU 30A controls the actuator 26 and the like such that the delivery vehicle 20 moves to the delivery destination (step S102). Next, the CPU 30A determines whether the delivery instruction for leaving the package in front of the front door is made (step S103). When the delivery instruction for leaving the package in front of the front door is not made (step S103: N), the CPU 30A proceeds to step S107, executes a standard delivery process, and proceeds to the process in step S109. The standard delivery process is a delivery process for when the unlock information is not used, and detailed description thereof will be omitted. When the delivery instruction for leaving the package in front of the front door is made (step S103: Y), the CPU 30A proceeds to the process in step S104.

In step S104, the CPU 30A determines whether the delivery destination is the dwelling unit 46 of the complex housing 40 including the shared door 44 with automatic lock function that can be unlocked as the unlock information managed by the key management system 72 is input to the unlock input unit 52 of the entrance 42 via wireless communication. Then, when the determination result is No in step S104 (step S104: N), the CPU 30A proceeds to step S107, executes the standard delivery process, and proceeds to the process in step S109. Further, when the determination result is Yes in step S104 (step S104: Y), the CPU 30A proceeds to the process in step S105.

In step S105, the CPU 30A determines whether the unlock information for unlocking the shared door 44 of the complex housing 40 including the dwelling unit 46 that is the delivery destination is acquired (step S105). When the determination result is No in step S105 (step S105: N), the CPU 30A proceeds to step S106, notifies the terminal device 60 of the user P of not giving the unlock information, proceeds to step S107, executes the standard delivery process, and proceeds to the process in step S109. Further, when the determination result is Yes in step S105 (step S105: Y), the CPU 30A proceeds to step S108, executes the delivery process that uses the unlock information, and proceeds to the process in step S109.

FIG. 6 shows an example of a delivery process routine that uses the unlock information by a flowchart. With reference to FIG. 6, a delivery process (step S108) that uses the unlock information will be described.

As shown in FIG. 6, in the delivery process that uses the unlock information, first, the CPU 30A notifies the terminal device 60 of the user P of the arrival time when the delivery vehicle 20 arrives at the entrance 42 via email (step S1081).

Next, the CPU 30A causes the peripheral information detection sensor 22 to detect the peripheral information of the delivery vehicle 20 at the entrance 42 (step S1082). At this time, the CPU 30A may control the actuator 26 such that the delivery vehicle 20 provided with the peripheral information detection sensor 22 performs a patrol operation.

Next, the CPU 30A determines whether a person is present in the peripheral area within the predetermined range from the delivery vehicle 20 at the entrance 42 based on the peripheral information detected by the peripheral information detection sensor 22 (step S1083). When a person is present in the peripheral area within the predetermined range from the delivery vehicle 20 at the entrance 42 (step S1083: Y), the CPU 30A returns to the process of step S1082. When a person is not present in the peripheral area within the predetermined range from the delivery vehicle 20 at the entrance 42 (step S1083: N), the process proceeds to step S1084, and the CPU 30A inputs the unlock information corresponding to the complex housing 40 to the unlock input unit 52 of the complex housing 40 via wireless communication. As a result, the shared door 44 can be opened. Further, by providing steps S1082 and S1083, it is possible to effectively prevent or suppress a person for which the unlock information is not input to the unlock input unit 52 of the complex housing 40 from entering a building (so-called tailgating).

Next, the CPU 30A causes the storage 30D to record information on the date and time, and the location at which the unlock information is input to the unlock input unit 52 (step S1085). Then, the CPU 30A notifies the terminal device 60 of the user P of the date and time at which the unlock information is input to the unlock input unit 52 by e-mail (step S1086). As a result, the user P can confirm the date and time at which the unlock information is input to the unlock input unit 52 so as to deliver the package 80 in front of the front door 46F of the own dwelling unit 46, so that the user P can entrust the delivery system to delivery of the package 80 in front of the front door 46F of the own dwelling unit 46.

Next, the CPU 30A causes the delivery vehicle 20 to enter from the entrance 42 to the inside and deliver the package 80 in front of the front door 46F of the dwelling unit 46 of the user P (step S1087). When the delivery vehicle 20 arrives in front of the front door 46F of the dwelling unit 46 of the user P, the CPU 30A controls the robot arm 28 such that the package 80 is placed in front of the front door 46F.

Next, the CPU 30A controls the actuator 26 and the like such that the delivery vehicle 20 moves to the location designated by the delivery management server 14 (step S1088), and returns. The location designated by the delivery management server 14 is, for example, a location in the vicinity of the delivery base vehicle 16 (location where packages are passed from the delivery base vehicle 16).

Returning to FIG. 5, in step S 109, the CPU 30A determines whether all the deliveries to be delivered by the delivery vehicle 20 have been completed based on the notification from the delivery management server 14. When all the deliveries to be delivered by the delivery vehicle 20 have not been completed (step S109: N), the CPU 30A returns to a process of step S101. When all the deliveries to be delivered by the delivery vehicle 20 are completed (step S109: Y), the CPU 30A ends the control process shown in FIG. 5.

As described above, according to the delivery system 10 of the present embodiment, the user P can entrust the delivery system 10 to delivery of the package 80 in front of the front door 46F of the dwelling unit 46 in the complex housing 40 in which the shared door 44 with automatic lock function of the entrance 42 can be unlocked as the unlock information is input via wireless communication. Supplementally, for example, when the user P is not present, the user P can entrust the delivery system 10 to delivery of groceries in front of the front door 46F of the dwelling unit 46 in the complex housing 40.

As a modification of the above embodiment, steps S1082 and S1083 in FIG. 6 can be omitted.

Further, as a modification of the above embodiment, before step S1081 in FIG. 6 or in place of step S1081 in FIG. 6, a step in which the CPU (30A) notifies the terminal device (60) of the user (P) of the scheduled time when the delivery vehicle (20) arrives at the entrance (42) by e-mail may be added. Further, as a modification of the above embodiment, after step S1087 in FIG. 6, a step in which the CPU (30A) notifies the terminal device (60) of the user (P) of the time when the package (80) is delivered in front of the front door (46F) of the dwelling unit (46) of the user (P) by e-mail may be added.

Further, for example, when the user (P) requests the delivery operator to deliver the package (80) in front of the front door (46F) of the dwelling unit (46) in the complex housing (40) including the shared door (44) with automatic lock function that can be unlocked as the unlock information managed by the key management system (72) is input to the unlock input unit (52) of the entrance (42) via wireless communication and a system in which the unlock information needs to be given to the delivery operator using the key management system (72), steps S105 and S106 in FIG. 5 can be omitted.

Further, as a modification of the above embodiment, the delivery vehicle (20) may be configured such that when a situation in which a person for which the unlock information is not input to the unlock input unit (52) of the complex housing (40) enters a building is acquired as an image, the image can be transmitted to the terminal device (60) and the like of the user (P).

Further, as a modification of the above embodiment, the notification unit 307 realized by the on-board unit 30 shown in FIG. 4 may be realized by the delivery management server (14), or the on-board unit (18) of the delivery base vehicle (16).

Further, in the above embodiment, the example in which the information on the e-mail address of the user P is included as the contact information of the user P is shown, but information on the telephone number of the user may be included as the contact information of the user. Further, a form in which a telephone is used in place of an e-mail as for various notifications to the user P may be adopted.

Further, the dwelling unit (46) of the complex housing (40) may be used as a residence or an office.

It should be noted that various processors other than the CPU may execute each process that is executed when the CPU 30A shown in FIG. 3 reads the software (program) in the above embodiment. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, each process may be executed by one of these various processors, or a combination of two or more processors of the same type or different types (for example, a combination of FPGAs, a combination of a CPU and an FPGA, and the like). Further, the hardware structure of these various processors is, more specifically, an electric circuit in which circuit elements such as semiconductor elements are combined.

Further, the program described in the above embodiment may be recorded on a recording medium such as a compact disc read-only memory (CD-ROM), a digital versatile disc read-only memory (DVD-ROM), and a universal serial bus (USB) memory to be provided. Further, the program may be downloaded from an external device via a network.

The present embodiment and several modifications described above can be carried out by appropriately combining the above embodiment and modifications thereof.

The example of the present disclosure has been described as above. However, it is not without saying that the present disclosure is not limited to the above example, and in addition to the above example, the present disclosure can be appropriately modified to be implemented without departing from the scope thereof.

What is claimed is:

1. A delivery system comprising:
a delivery vehicle configured to be able to deliver a package in front of a front door of a dwelling unit in a complex housing including a shared door with automatic lock function that is installed at an entrance such that the shared door is able to be opened and closed, and that is able to be opened as unlock information managed by a key management system is input to an unlock input unit of the entrance via wireless communication;
a delivery information acquisition unit that acquires information on delivery including delivery destination information on the package and information indicating presence or absence of a delivery instruction for leaving the package in front of the front door;
a contact information acquisition unit that acquires contact information on a user of delivery destination;
an unlock information acquisition unit that acquires the unlock information in the complex housing based on information from the key management system when determination is made that the delivery instruction for leaving the package in front of the front door is made and the delivery destination indicated by the delivery destination information is the dwelling unit in the complex housing based on information acquired by the delivery information acquisition unit;
an unlock request unit that inputs the unlock information corresponding to the complex housing to the unlock input unit of the complex housing via the wireless communication based on information acquired by the unlock information acquisition unit when the delivery vehicle for delivering the package arrives at the complex housing and when determination is made that the delivery instruction for leaving the package in front of the front door is made based on information acquired by the delivery information acquisition unit;
a record unit that records information on a date and time, and a location at which the unlock request unit inputs the unlock information to the unlock input unit; and
a notification unit that notifies the user of the date and time at which the unlock information is input to the unlock input unit so as to deliver the package in front of the front door of the dwelling unit of the user based on information acquired by each of the delivery information acquisition unit and the contact information acquisition unit and information recorded in the record unit.

2. The delivery system according to claim 1, comprising
a peripheral information detection sensor that detects peripheral information of the delivery vehicle; and
a determination unit that determines whether a person is present in a peripheral area within a predetermined range from the delivery vehicle at the entrance based on the peripheral information detected by the peripheral information detection sensor when the delivery vehicle arrives at the entrance of the complex housing, wherein the unlock request unit inputs the unlock information to the unlock input unit after the determination unit determines that a person is not present in the peripheral area.
